(19) United States
(12) Patent Application Publication
(10) Pub. No.: US 2023/0360002 A1
(43) Pub. Date: Nov. 9, 2023

(54) RECOMMENDATION DEVICE, RECOMMENDATION SYSTEM, RECOMMENDATION METHOD, AND STORAGE MEDIUM

(71) Applicant: NEC Corporation, Minato-ku, Tokyo (JP)

(72) Inventor: Yasuhiro AJIRO, Tokyo (JP)

(73) Assignee: NEC Corporation, Minato-ku, Tokyo (JP)

(21) Appl. No.: 18/038,074

(22) PCT Filed: Nov. 27, 2020
(86) PCT No.: PCT/JP2020/044291

§ 371 Date: May 22, 2023

(51) Int. Cl. G06Q 10/1053

(52) U.S. Cl. CPC G06Q 10/1053

(57) ABSTRACT

To output a more suitable matching candidate in business matching between companies, a recommendation apparatus (10) includes an extracting section (11) that extracts, on the basis of a predetermined extraction condition, core phrases respectively from (i) target company information including a cooperation detail desired by a target company and (ii) cooperation candidate company information including a cooperation detail desired by a cooperation candidate company of the target company; a specifying section (12) that specifies a recommended company from among the cooperation candidate company on the basis of the core phrases extracted by the extracting section (11); and an output section (13) that outputs information indicative of the recommended company specified by the specifying section (12).

### TECHNICAL FIELD

The present invention relates to a technology for business matching between companies.

### BACKGROUND ART

A business matching system is used which presents a combination of companies suitable for doing business together. Patent Literature 1 discloses a business matching system which extracts, on the basis of segment data, an effective business partner for a company that is a target of matching, wherein the segment data is obtained by classifying attribute data, financial data, and transaction data of a company in accordance with predetermined classification items.

### CITATION LIST

### Patent Literature

[Patent Literature 1]
Japanese Patent Application Publication, Tokukai, No. 2017-182243

### SUMMARY OF INVENTION

### Technical Problem

The business matching system described in Patent Literature 1 extracts, on the basis of the segment data, a candidate for a business partner of the company which is the target of matching, but has room for improvement in terms of presenting a more suitable candidate.

An example aspect of the present invention is accomplished in view of the above problem. That is, an example object in accordance with an example aspect of the present invention is to provide a technology that makes it possible to output a more suitable matching candidate in business matching between companies.

### Solution to Problem

A recommendation apparatus in accordance with an example aspect of the present invention includes: an extracting means that extracts, on the basis of a predetermined extraction condition, core phrases respectively from (i) target company information including a cooperation detail desired by a target company and (ii) cooperation candidate company information including a cooperation detail desired by a cooperation candidate company of the target company; a specifying means that specifies a recommended company from among the cooperation candidate company on the basis of the core phrases extracted by the extracting means; and an output means that outputs information indicative of the recommended company specified by the specifying means.

A recommendation method in accordance with an example aspect of the present invention includes: extracting, on the basis of a predetermined extraction condition, core phrases respectively from (i) target company information including a cooperation detail desired by a target company and (ii) cooperation candidate company information including a cooperation detail desired by a cooperation candidate company of the target company; specifying a recommended company from among the cooperation candidate company on the basis of the core phrases; and outputting information indicative of the recommended company, the extracting, the specifying, and the outputting being each carried out by a recommendation apparatus.

A program in accordance with an example aspect of the present invention is a program for causing a computer to function as a recommendation apparatus, the program causing the computer to function as: an extracting means that extracts, on the basis of a predetermined extraction condition, core phrases respectively from (i) target company information including a cooperation detail desired by a target company and (ii) cooperation candidate company information including a cooperation detail desired by a cooperation candidate company of the target company; a specifying means that specifies a recommended company from among the cooperation candidate company on the basis of the core phrases extracted by the extracting means; and an output means that outputs information indicative of the recommended company specified by the specifying means.

A storage medium in accordance with an example aspect of the present invention is a storage medium storing therein a program for causing a computer to function as a recommendation apparatus, the program causing the computer to function as: an extracting means that extracts, on the basis of a predetermined extraction condition, core phrases respectively from (i) target company information including a cooperation detail desired by a target company and (ii) cooperation candidate company information including a cooperation detail desired by a cooperation candidate company of the target company; a specifying means that specifies a recommended company from among the cooperation candidate company on the basis of the core phrases extracted by the extracting means; and an output means that outputs information indicative of the recommended company specified by the specifying means.

A recommendation system in accordance with an example aspect of the present invention includes a recommendation apparatus and a user terminal, the recommendation apparatus including: an extracting means that extracts, on the basis of a predetermined extraction condition, core phrases respectively from (i) target company information including a cooperation detail desired by a target company indicated by input information and (ii) cooperation candidate company information including a cooperation detail desired by a cooperation candidate company of the target company; a specifying means that specifies a recommended company from among the cooperation candidate company on the basis of the core phrases extracted by the extracting means; and an output means that outputs information indicative of the recommended company specified by the specifying means, the user terminal including: an input means that obtains the input information; and a displaying means that displays the information presented by the recommendation apparatus and indicative of the recommended company.

### Advantageous Effects of Invention

According to an example aspect of the present invention, it is possible to output a more suitable matching candidate in business matching between companies.

### BRIEF DESCRIPTION OF DRAWINGS

FIG. 1 is a block diagram illustrating a configuration of a recommendation apparatus in accordance with a first example embodiment of the present invention.

FIG. 2 is a flowchart illustrating a flow of a recommendation method in accordance with the first example embodiment of the present invention.

FIG. 3 is a block diagram illustrating a configuration of a recommendation system in accordance with a second example embodiment of the present invention.

FIG. 4 is a flowchart illustrating a flow of a recommendation method in accordance with the second example embodiment of the present invention.

FIG. 5 is a block diagram illustrating a configuration of a recommendation system in accordance with a third example embodiment of the present invention.

FIG. 6 is a view illustrating a specific example of a need information database in accordance with the third example embodiment of the present invention.

FIG. 7 is a view illustrating a specific example of a keyword dictionary in accordance with the third example embodiment of the present invention.

FIG. 8 is a flowchart illustrating a flow of a recommendation method in accordance with the third example embodiment of the present invention.

FIG. 9 is a view illustrating an example screen displayed in the third example embodiment of the present invention.

FIG. 10 is a block diagram illustrating a configuration of a recommendation system in accordance with a fourth example embodiment of the present invention.

FIG. 11 is a view illustrating a specific example of a company information database in the fourth example embodiment of the present invention.

FIG. 12 is a flowchart illustrating a flow of a recommendation method in accordance with the fourth example embodiment of the present invention.

FIG. 13 is a block diagram illustrating a configuration of a recommendation system in accordance with a fifth example embodiment of the present invention.

FIG. 14 is a flowchart illustrating a flow of a recommendation method in accordance with the fifth example embodiment of the present invention.

FIG. 15 is a block diagram illustrating a configuration of a recommendation system in accordance with a sixth example embodiment of the present invention.

FIG. 16 is a flowchart illustrating a flow of a recommendation method in accordance with the sixth example embodiment of the present invention.

FIG. 17 is a view illustrating an example screen displayed in the sixth example embodiment of the present invention.

FIG. 18 is a block diagram illustrating an example of a hardware configuration of a recommendation apparatus in accordance with each of the example embodiments of the present invention.

### EXAMPLE EMBODIMENTS

### First Example Embodiment

The following will discuss in detail a first example embodiment of the present invention, with reference to drawings. The present example embodiment is an embodiment that serves as a base for example embodiments which will be described later.

<Configuration of Recommendation Apparatus>

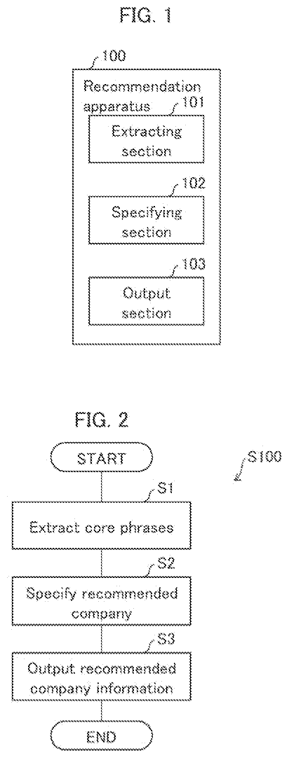

The following will discuss a configuration of a recommendation apparatus 100 in accordance with the present example embodiment, with reference to FIG. 1. FIG. 1 is a block diagram illustrating a configuration of the recommendation apparatus 100. The recommendation apparatus 100 is an apparatus that presents a recommended company which is recommended as a matching candidate of a target company in business matching.

As illustrated in FIG. 1, the recommendation device 100 includes an extracting section 101, a specifying section 102, and an output section 103. The extracting section 101 is configured to realize an extracting means in the present example embodiment. The specifying section 102 is configured to realize a specifying means in the present example embodiment. The output section 103 is configured to realize an output means in the present example embodiment.

The extracting section 101 extracts, on the basis of a predetermined extraction condition, core phrases from target company information and cooperation candidate company information respectively, the target company information including a cooperation detail desired by a target company, the cooperation candidate company information including a cooperation detail desired by a cooperation candidate company of the target company.

A cooperation detail that is desired is a description of business in which a company seeks cooperation with another company. For example, a cooperation detail that is desired includes a feature of a company desired as a cooperation partner. A cooperation detail that is desired can include at least one selected from the group consisting of a name of the company, a description of business of the company, a service provided by the company, a product provided by the company, and a corporate philosophy of the company.

Target company information is information that includes a cooperation detail desired by the target company. Target company information includes, for example, a text representing a need of a company or a text explaining or describing a company. A core phrase is a phrase included in target company information. For example, a core phrase can include a character string of a part or an entirety of a text related to a company. A core phrase, for example, may include one or more sentences, or may be a portion of a single sentence extracted from the single sentence. An extraction condition is a condition for extracting a core phrase from target company information. A process of extracting a core phrase on the basis of an extraction condition includes, for example, a process of extracting a core phrase with use of a keyword dictionary (a list of keywords) in which one or more keywords are registered.

Hereinafter, a company other than a target company among a plurality of companies may be referred to as a cooperation candidate company. Target company information and cooperation candidate company information are, for example, stored in a storage apparatus. The storage apparatus can be included in the recommendation apparatus 100 or can be an external apparatus communicatively connected to the recommendation apparatus 100. For example, the extracting section 101 analyzes target company information and cooperation candidate company information by natural language processing such as morphological analysis and extracts, as a core phrase, a part with respect to which an analysis result satisfies a predetermined condition. As a method of natural language processing, a well-known technique can be employed. Note that a process of extracting core phrases from target company information and cooperation candidate company information respectively is not limited to the one described above.

The specifying section 102 specifies a recommended company from among a cooperation candidate company(ies) on the basis of core phrases extracted by the extracting section 101. For example, the specifying section 102 compares a core phrase extracted from target company information with a core phrase extracted from cooperation candidate company information, and specifies, as a recommended company from among one or more cooperation candidate companies, a cooperation candidate company with respect to which a degree of similarity satisfies a predetermined condition. As a technique for determining similarity between core phrases, a well-known technique can be employed. Note that a process of extracting a recommended company with reference to core phrases of companies is not limited to the one described above.

The output section 103 outputs information indicative of a recommended company specified by the specifying section 102. Hereinafter, information indicative of a recommended company may be referred to as recommended company information. For example, the output section 103 outputs recommended company information to a display apparatus. The display apparatus can be included in the recommendation apparatus 100 or can be an external apparatus communicatively connected to the recommendation apparatus 100. The output section 103 may output recommended company information to another apparatus such as a speaker or an image forming apparatus, and may output recommended company information to an external storage apparatus so that the recommended company information is stored in the external storage apparatus. Note that a process of outputting a recommended company to a user is not limited to the one described above.

<Flow of Recommendation Method>

The following will discuss, with reference to FIG. 2, a flow of a recommendation method S100 carried out by the recommendation apparatus 100 configured as described above. FIG. 2 is a flowchart illustrating a flow of the recommendation method S100. As illustrated in FIG. 2, the recommendation method S100 includes steps S1 to S3.

(Step S1)

In the step S1, the extracting section 101 extracts, on the basis of a predetermined extraction condition, core phrases from target company information and cooperation candidate company information respectively, the target company information including a cooperation detail desired by a target company, the cooperation candidate company information including a cooperation detail desired by each of a cooperation candidate company(ies) of the target company.

(Step S2)

In the step S2, the specifying section 102 specifies a recommended company from among the cooperation candidate company(ies) on the basis of the core phrases extracted by the extracting section 101.

(Step S3)

In the step S3, the output section 103 outputs recommended company information indicative of the recommended company specified by the specifying section 102.

### <Example Advantage of Present Example Embodiment>

As described above, the recommendation apparatus 100 in accordance with the present example embodiment specifies a recommended company on the basis of a core phrase which has been extracted from target company information on the basis of an extraction condition, rather than specifying a recommended company on the basis of the entire target company information. Thus, the recommendation apparatus 100 in accordance with the present example embodiment can output a more suitable matching candidate in business matching between companies.

### Second Example Embodiment

The following will discuss in detail a second example embodiment of the present invention, with reference to drawings. Note that any constituent element that is identical in function to a constituent element described in the first example embodiment will be given the same reference numeral, and a description thereof will not be repeated.

<Configuration of Recommendation System>

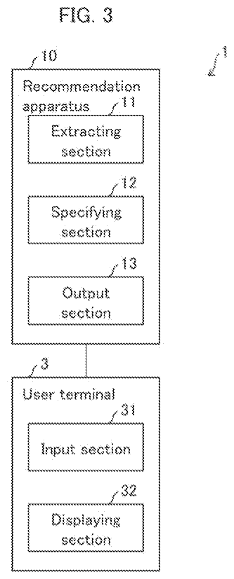

A recommendation system 1 in accordance with the present example embodiment is a system that presents to a user a recommended company which is recommended as a matching candidate of a target company in business matching. The following will discuss a configuration of the recommendation system 1, with reference to FIG. 3. FIG. 3 is a block diagram illustrating a configuration of the recommendation system 1. As illustrated in FIG. 3, the recommendation system 1 includes a recommendation apparatus 10 and a user terminal 3. The recommendation apparatus 10 and the user terminal 3 are communicatively connected to each other.

(Configuration of Recommendation Apparatus)

The recommendation apparatus 10 includes an extracting section 11, a specifying section 12, and an output section 13. The extracting section 11 is configured to realize an extracting means in the present example embodiment. The specifying section 12 is configured to realize a specifying means in the present example embodiment. The output section 13 is configured to realize an output means in the present example embodiment.

The extracting section 11 differs from the extracting section 101 in accordance with the first example embodiment in receiving, from the user terminal 3, input information indicative of a target company among a plurality of companies. In other respects, the extracting section 11 is configured similarly as the extracting section 101, and detailed descriptions thereof will not be repeated.

The specifying section 12 is configured similarly as the specifying section 102 in accordance with the first example embodiment, and detailed descriptions thereof will not be repeated.

The output section 13 differs from the output section 103 in accordance with the first example embodiment in outputting, to the user terminal 3, recommended company information indicative of a recommended company specified by the specifying section 12. Specifically, the output section 13 transmits, to the user terminal 3, information indicative of a recommended company specified by the specifying section 12. In other respects, the output section 13 is configured similarly as the output section 103, and detailed descriptions thereof will not be repeated.

(Configuration of User Terminal)

As illustrated in FIG. 3, the user terminal 3 includes an input section 31 and a displaying section 32. The input section 31 is configured to realize an input means in the present example embodiment. The displaying section 32 is configured to realize a displaying means in the present example embodiment. The user terminal 3 is connected to an input apparatus and a display apparatus (both not illustrated).

The input section 31 obtains, through the input apparatus, input information indicative of a target company among a plurality of companies. The input section 31 transmits the input information obtained to the recommendation apparatus 10.

The displaying section 32 displays, on the display apparatus, the information indicative of a recommended company outputted from the recommendation apparatus 10.

### <Flow of Recommendation Method>

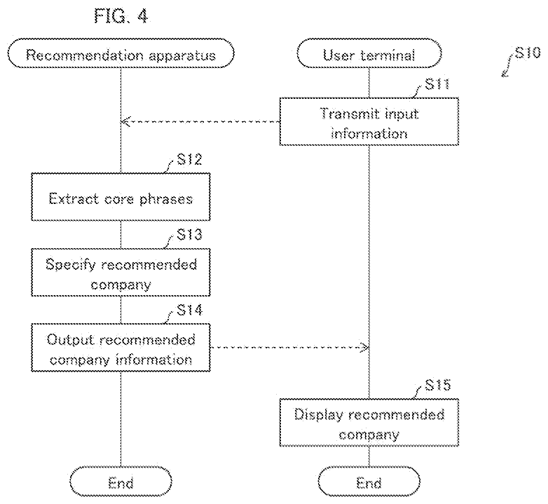

The following will discuss, with reference to FIG. 4, a flow of a recommendation method S10 carried out by the recommendation system 1 configured as described above. FIG. 4 is a flowchart illustrating a flow of the recommendation method S10. As illustrated in FIG. 4, the recommendation method S10 includes steps S11 to S15.

(Step S11)

In the step S11, the input section 31 of the user terminal 3 obtains input information indicative of a target company among a plurality of companies, and transmits the input information obtained to the recommendation apparatus 10.

(Step S12)

In the step S12, the extracting section 11 extracts, on the basis of a predetermined extraction condition, core phrases from target company information and cooperation candidate company information respectively, the target company information including a cooperation detail desired by the target company, the cooperation candidate company information including a cooperation detail desired by each of a cooperation candidate company(ies) of the target company.

(Step S13)

In the step S13, the specifying section 12 specifies a recommended company from among the cooperation candidate company(ies) on the basis of the core phrases extracted by the extracting section 11.

(Step S14)

In the step S14, the output section 13 outputs, to the user terminal 3, information indicative of the recommended company specified by the specifying section 102. Specifically, the output section 13 transmits recommended company information to the user terminal 3.

(Step S15)

In the step S15, the displaying section 32 of the user terminal 3 displays, on the display apparatus, the recommended company information transmitted from the recommendation apparatus 10.

<Example Advantage of Present Example Embodiment>

With the above configuration, the present example embodiment allows a user of the user terminal to know a recommended company, which is a matching candidate of a target company, on a display screen by inputting information indicative of the target company.

### Third Example Embodiment

The following will discuss in detail a third example embodiment of the present invention, with reference to drawings. Note that any constituent element that is identical in function to a constituent element described in the first example embodiment or the second example embodiment will be given the same reference numeral, and a description thereof will not be repeated.

<Configuration of Recommendation System>

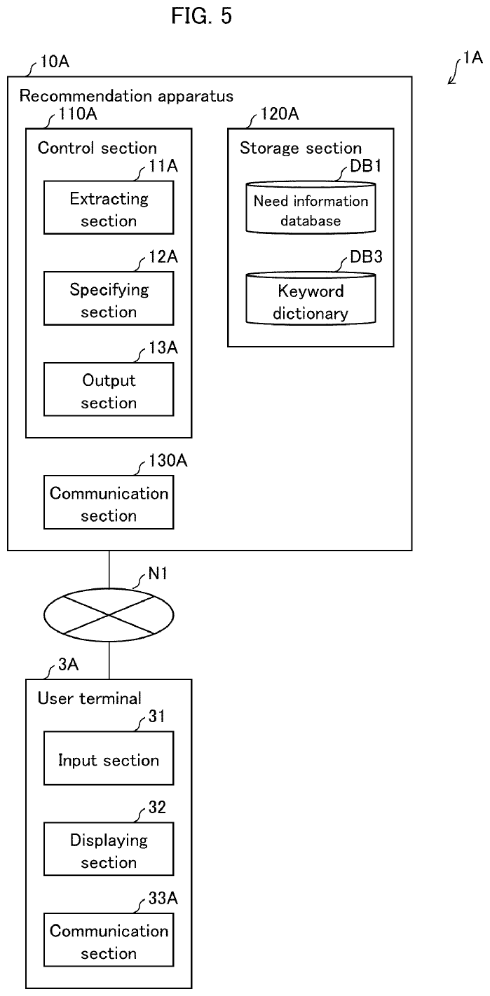

The following will discuss a configuration of a recommendation system 1A in accordance with the present example embodiment, with reference to FIG. 5. FIG. 5 is a block diagram illustrating a configuration of the recommendation system 1A. The recommendation system 1A is a system that refers to a need text of each company and outputs information indicative of a recommended company which is recommended as a matching candidate of a target company designated by a user. A need text of a company is a text representing a need of the company and is an example of target company information and cooperation candidate company information in this specification.

As illustrated in FIG. 5, the recommendation system 1A includes a recommendation apparatus 10A and a user terminal 3A. The recommendation apparatus 10A and the user terminal 3A are communicatively connected to each other via a network N1. Note that although FIG. 5 illustrates a single user terminal 3A, the number of user terminals 3A to which the recommendation apparatus 10A is connected is not limited. The network N1 is, for example, a wireless local area network (LAN), a wired LAN, a wide area network (WAN), a public network, a mobile data communication network, or a combination of these networks. Note that a configuration of the network N1 is not limited to these examples.

(Configuration of User Terminal)

As illustrated in FIG. 5, the user terminal 3A includes a communication section 33A in addition to the configurations similar to those of the user terminal 3 in accordance with the second example embodiment.

The communication section 33A transmits and receives information to and from the recommendation apparatus 10A via the network N1. Hereinafter, a case where the communication section 33A transmits and receives information to and from the recommendation apparatus 10A may be referred to simply as a case where the user terminal 3A transmits and receives information to and from the recommendation apparatus 10A.

(Configuration of Recommendation Apparatus)

As illustrated in FIG. 5, the recommendation apparatus 10A includes a control section 110A, a storage section 120A, and a communication section 130A. The control section 110A includes an extracting section 11A, a specifying section 12A, and an output section 13A. The extracting section 11A is configured to realize an extracting means in the present example embodiment. The specifying section 12A is configured to realize a specifying means in the present example embodiment. The output section 13A is configured to realize an output means in the present example embodiment. Details of these functional blocks included in the control section 110A will be described later.

The storage section 120A stores therein a need information database DB1 and a keyword dictionary DB3. Details of the need information database DB1 and the keyword dictionary DB3 will be described later. The storage section 120A is configured to realize a storage apparatus in the present example embodiment.

The communication section 130A transmits and receives information to and from the user terminal 3A via the network N1, under the control of the control section 110A. Hereinafter, a case where the control section 110A transmits and receives information to and from the user terminal 3A via the communication section 130A may be referred to simply as a case where the control section 110A transmits and receives information to and from the user terminal 3A.

(Need Information Database)

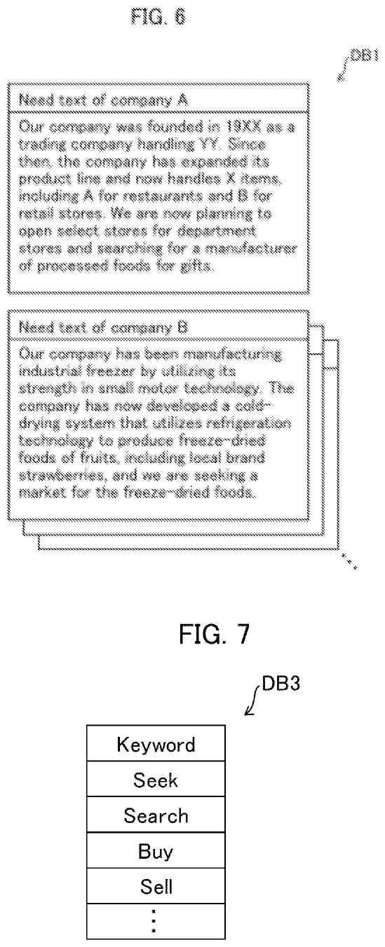

The following will discuss a configuration of the need information database DB1, with reference to FIG. 6. FIG. 6 is a view illustrating a specific example of the need information database DB1. As illustrated in FIG. 6, the need information database DB1 stores therein, for each of a plurality of companies, information including a need text. The need text of each company in the present example embodiment is an example of “target company information” and “cooperation candidate company information” recited in Claims. In other words, the need information database DB1 stores therein target company information and cooperation candidate company information.

The need text of each company includes, for example, a phrase indicative of a desired feature of a cooperation partner of the company. For example, in FIG. 6, the phrase “searching for a manufacturer of processed foods for gifts” included in a need text of a company A illustrates an example of a desired feature of a cooperation partner of the company A. Further, for example, in FIG. 6, the phrase “seeking a market for the freeze-dried foods” included in a need text associated with a company B illustrates an example of a desired feature of a cooperation partner of the company B.

(Company Having Need Text Registered)

Hereinafter, a company whose information including a need text is stored in the need information database DB1 is also referred to as a “company having a need text registered in the need information database DB1” or simply as a “company having a need text registered”. There can be a case in which a new need text of a company is additionally registered after the recommendation apparatus 10A has started operating. Further, there can be a case in which a need text already registered is altered after the recommendation apparatus 10A has started operating. Further, there can be a case in which a need text of a company already registered is deleted after the recommendation apparatus 10A has started operating.

(Plurality of Companies)

A “plurality of companies” means a plurality of companies each of which has a need text registered in the need information database DB1.

(Target Company)

A “target company” means a company that is a target of matching among the plurality of companies. The target company is, for example, designated by a user of the recommendation apparatus 10A.

(Recommended Company)

A “recommended company” means a company which is among the plurality of companies and recommended by the recommendation apparatus 10A as a cooperation partner of the target company, i.e., recommended as a matching candidate of the target company.

(Cooperation Candidate Company)

A “cooperation candidate company” means a company other than the target company among the plurality of companies. The cooperation candidate company is a company that serves as a candidate for a recommended company. For a single target company, there are one or more cooperation candidate companies. In the following description, for convenience of explanation, a target company, a recommended company, and a cooperation candidate company may be referred to simply as a “company” in a case where it is not necessary to distinguish between the target company, the recommended company, and the cooperation candidate company.

(Keyword Dictionary)

FIG. 7 is a view illustrating a specific example of the keyword dictionary DB3. The keyword dictionary DB3 is a list in which one or more words each used as a keyword in a process of extracting core phrases are registered. The one or more keywords registered in the keyword dictionary are each, for example, a word that is likely to be included in a text representing a need of a company. A process of extracting core phrases with use of the keyword dictionary DB3 is an example of a process of extracting core phrases with use of a predetermined extraction condition in this specification.

In the example illustrated in FIG. 7, words such as “seek”, “search”, “buy”, and “sell” are registered in the keyword dictionary DB. The keyword dictionary is generated by, for example, an administrator of the recommendation system 1A.

(Core Phrase)

A core phrase is a phrase which is extracted from a need text of a company with use of the keyword dictionary DB3. A core phrase is, for example, a phrase which serves as a core of a need of a company. A core phrase includes, for example, one or more keywords registered in the keyword dictionary DB3.

(Configuration of Extracting Section)

The extracting section 11A extracts, on the basis of a predetermined extraction condition, core phrases respectively from a need text of the target company and a need text of a cooperation candidate company which are stored in the need information database DB1. Details of a method of extracting core phrases will be described later.

(Configuration of Specifying Section)

The specifying section 12A specifies a recommended company from among one or more cooperation candidate companies on the basis of the core phrases extracted by the extracting section 11A. Details of a method of specifying a recommended company will be described later.

(Configuration of Output Section)

The output section 13A outputs recommended company information indicative of the recommended company specified by the specifying section 12A. For example, the output section 13A outputs the recommended company information by transmitting the recommended company information to the user terminal 3A.

<Flow of Recommendation Method>

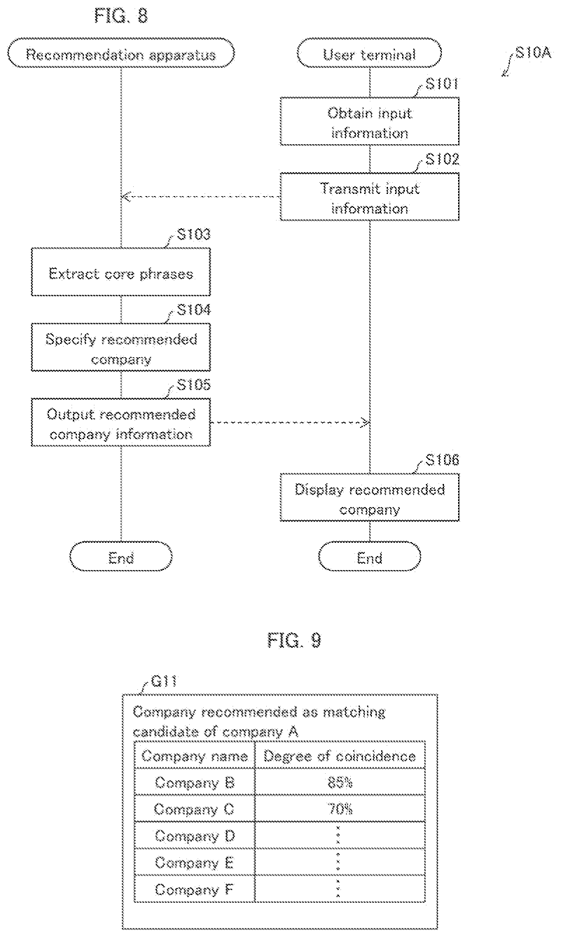

The following will discuss, with reference to FIG. 8, a flow of a recommendation method S10A carried out by the recommendation system 1A configured as described above. FIG. 8 is a flowchart illustrating a flow of the recommendation method S10A. As illustrated in FIG. 8, the recommendation method S10A includes steps S101 to S106.

(Step S101)

In the step S101, an input section 31 of the user terminal 3A obtains input information through an input apparatus. The input information is information indicative of a target company and is, for example, identification information for identifying a target company. The input information is inputted, for example, by operation of the input apparatus by a user of the user terminal 3A. For example, the user may input, with use of the input apparatus, the identification information indicative of a target company, or may input the input information by carrying out, with use of the input apparatus, an operation of designating a target company from among the plurality of companies.

(Step S102)

In the step S102, the input section 31 transmits the input information obtained to the recommendation apparatus 10A. The extracting section 11A receives the input information via the communication section 130A.

(Step S103)

In the step S103, the extracting section 11A refers to the need information database DB1 and extracts, on the basis of a predetermined extraction condition, core phrases from a need text of the target company and a need text of each of one or more cooperation candidate companies.

In this example, the extracting section 11A reads out, from the need information database DB1, a need text of the target company indicated by the input information received from the user terminal 3. The extracting section 11A, for example, carries out natural language processing on the need text thus read out and extracts a phrase(s) from the read-out need text as a core phrase(s), the phrase(s) each containing a keyword(s) registered in the keyword dictionary DB3 or a keyword(s) similar to the registered keyword(s). In this example, the natural language processing is, for example, morphological analysis, N-gram analysis, or the like.

A core phrase extracted by the extracting section 11A may include one or more sentences, or may be a phrase that is a portion of a single sentence extracted from the single sentence. For example, the extracting section 11 may extract, as a core phrase, a sentence including a keyword, or may extract, as a core phrase, a plurality of sentences which include (i) a sentence including a keyword and (ii) sentences followed by or following that sentence. Further, the extracting section 11 may extract, as a core phrase, a portion of a sentence including a keyword which portion includes the keyword.

In the following description, a core phrase extracted from a need text of a target company may be referred to simply as a “core phrase of a target company.” Likewise, a core phrase extracted from a need text of a cooperation candidate company may be referred to as a “core phrase of a cooperation candidate company”.

For example, in a case where the target company is a “company A”, the extracting section 11A uses the keyword dictionary DB3 illustrated in FIG. 7 and extracts, as a core phrase of the company A, the phrase “searching for a manufacturer of processed foods for gifts” from a need text of the company A illustrated in FIG. 6.

The extracting section 11A also extracts a core phrase from a need text of a cooperation candidate company with use of the keyword dictionary DB3. For example, in a case where a “company B” is included among cooperation candidate companies, the extracting section 11A uses the keyword dictionary DB3 illustrated in FIG. 7 and extracts, as a core phrase of the company B, the phrase “seeking a market for the freeze-dried foods” from a need text of the company B illustrated in FIG. 6.

The number of core phrases extracted by the extracting section 11A differs depending on the length, the content, and the like of a need text of a company. The extracting section 11A may extract a single core phrase from a need text of a company, or may extract a plurality of core phrases from a need text of a company. There may be cases where the extracting section 11A cannot extract a core phrase from a need text, such as when the need text of the target company is too short. In a case where it is not possible to extract a core phrase with use of a keyword, the extracting section 11A may, for example, extract the entire need text of a company as a core phrase.

(Step S104)

In the step S104, the specifying section 12A specifies a recommended company from among the one or more cooperation candidate companies on the basis of the core phrases extracted by the extracting section 11A. In this example, the specifying section 12A calculates a degree of similarity between the target company and each of the one or more cooperation candidate companies on the basis of the core phrases extracted by the extracting section 11A, and specifies a recommended company with use of the degree of similarity thus calculated. The degree of similarity is information indicative of an extent to which the core phrase of the target company and a core phrase of each of the one or more cooperation candidate companies are similar to each other.

A method by which the specifying section 12A determines similarity between core phrases can specifically be, for example, a (a) method based on interword distances, a (b) method based on an inter-document distance, or a (c) method based on a trained model that has been trained by machine learning. Details of these methods will be described below. Note that a method of determining similarity between core phrases is not limited to these examples.

(a: Method Based on Interword Distances)

In a case where this method is employed, the specifying section 12A calculates a degree of similarity between the core phrase of the target company and a core phrase of each cooperation candidate company on the basis of interword distances. Specifically, the specifying section 12A calculates an interword distance for each combination of a word included in the core phrase of the target company and a word included in the core phrase of the cooperation candidate company. The specifying section 12A may use, as words included in the core phrases, for example, a result of analysis in the natural language processing carried out by the extracting section 11A in the step S102. The specifying section 12A also calculates a degree of similarity between the core phrase of the target company and the core phrase of the cooperation candidate company, with use of interword distances thus calculated.

For example, the specifying section 12A calculates an interword distance for each combination of a word w1i (i=1, 2, . . . , n) included in the core phrase of the target company and a word w2j (j=1, 2, . . . , m) included in a core phrase of a cooperation candidate company. Note that n and m are natural numbers. In this case, there are n×m combinations of the word w1i and the word w2j. In other words, the specifying section 12A calculates n×m interword distances. In a case where a feature of each word w1i and a feature of each word w2j are expressed in the form of vectors, an interword distance is represented by an angle between the two vectors or by a Euclidean distance between the vectors. As a technique for expressing a feature of a word in the form of a vector, it is possible to use a trained model that has been trained by machine learning so as to output a feature vector upon receiving input of a word. A technique such as word2vec can be employed as such a trained model, although the present example embodiment is not limited thereto.

The specifying section 12A calculates a degree of similarity between the core phrase of the target company and the core phrase of the cooperation candidate company, with use of a statistical value of interword distances. In other words, the specifying section 12A calculates a distance between feature vectors related to the core phrases extracted by the extracting section 11A, the distance being in a predetermined feature space, and calculates the degree of similarity on the basis of the distance calculated. The predetermined feature space is, for example, a Euclidean space in which features of words are expressed in the form of vectors. The distance between the feature vectors related to the core phrases is, for example, the statistical value of interword distances described above.

As a specific example, the specifying section 12A calculates the degree of similarity such that the degree of similarity increases as an average value of interword distances of all combinations of the word w1i and the word w2j decreases. As another specific example, the specifying section 12A calculates the degree of similarity such that the degree of similarity increases as an average value of the respective interword distances of a predetermined number of combinations among the all combinations decreases, the predetermined number of combinations being the top predetermined number of combinations ranked in ascending order of interword distances among the all combinations.

The specifying section 12A extracts, as a recommended company(ies), one or more cooperation candidate companies for each of which the calculated degree of similarity meets a predetermined condition. For example, the specifying section 12A extracts, as a recommended company(ies), one or more cooperation candidate companies for each of which the degree of similarity is not less than a threshold. For example, the specifying section 12A can specify, as a recommended company(ies), the top predetermined number of cooperation candidate companies ranked in descending order of degrees of similarity.

(b: Method Based on Inter-Document Distance)

In a case where this method is employed, the specifying section 12A calculates a degree of similarity between the core phrase of the target company and a core phrase of each cooperation candidate company on the basis of an inter-document distance. In other words, the specifying section 12A calculates a distance between feature vectors related to the core phrases extracted by the extracting section 11A, the distance being in a predetermined feature space, and calculates the degree of similarity on the basis of the distance calculated. The predetermined feature space is, for example, a Euclidean space in which features of texts are expressed in the form of vectors. The distance between the feature vectors related to the core phrases is, for example, the inter-document distance described above.

In a case where a feature of each core phrase is expressed in the form of a vector, an inter-document distance between core phrases is represented by an angle between two vectors or by a Euclidean distance between the vectors. As a technique for representing a feature of a core phrase in the form of a vector, it is possible to use a trained model that has been trained by machine learning so as to output a feature vector upon receiving input of a core phrase. A technique such as doc2vec can be employed as such a trained model, although the present example embodiment is not limited thereto. The specifying section 12A calculates the degree of similarity such that the degree of similarity increases as the inter-document distance decreases.

The specifying section 12A extracts, as a recommended company(ies), one or more cooperation candidate companies for each of which the calculated degree of similarity meets a predetermined condition. As an example, the specifying section 12A extracts, as a recommended company(ies), one or more cooperation candidate companies for each of which the degree of similarity is not less than a threshold. Further, the specifying section 12A can specify, as recommended companies, the top predetermined number of cooperation candidate companies ranked in descending order of degrees of similarity.

The case in which the degree of similarity is determined by the above method (a) or (b) is, in other words, a case in which the specifying section 12A calculates a distance between feature vectors related to the core phrases extracted by the extracting section 11A, the distance being in a predetermined feature space, and specifies a recommended company on the basis of the distance calculated. The distance between the feature vectors related to the core phrases is, for example, the statistical value of interword distances in (a) or the inter-document distance in (b). The predetermined feature space is, for example, a Euclidean space in which features of words or documents are expressed in the form of vectors.

(c: Method Based on Trained Model)

In a case where this method is employed, the specifying section 12A uses a trained model that has been trained by machine learning so as to output information indicative of similarity between respective core phrases of two companies, upon receiving input of the core phrases. The specifying section 12A inputs the core phrase of the target company and a core phrase of a cooperation candidate company into the trained model. Further, the specifying section 12A specifies, as a recommended company(ies), one or more cooperation candidate companies for each of which “information indicative of similarity” is outputted from the trained model.

For example, the specifying section 12A generates the trained model in advance by machine learning in the following manner. The specifying section 12A uses, as training data, respective core phrases of two companies that have had an actual case of matching therebetween among a plurality of companies, and carries out training so that the trained model outputs, upon receiving input of these core phrases, information indicative of similarity between the core phrases. Further, for example, the specifying section 12A carries out training so that the trained model outputs, upon receiving input of respective core phrases of two companies that have never had a case of matching therebetween, information indicative of non-similarity between the core phrases. For example, the specifying section 12A may generate the trained model by transfer learning or fine tuning with use of a pre-trained model. Specific examples of the pre-trained model include, but are not limited to, bidirectional encoder representations from transformers (BERT) and the like. Note that the trained model can have been trained to output a degree of similarity, instead of outputting information indicative of similarity or non-similarity.

In this case, the specifying section 12A extracts, as a recommended company(ies), one or more cooperation candidate companies for each of which the outputted degree of similarity meets a predetermined condition. For example, the specifying section 12A specifies, as a recommended company(ies), one or more cooperation candidate companies for each of which the degree of similarity is not less than a threshold. Further, for example, the specifying section 12A can specify, as recommended companies, the top predetermined number of cooperation candidate companies ranked in descending order of degrees of similarity.

(Step S105)

In the step S105, the output section 13A (i) generates recommended company information representing the recommended company(ies) specified by the specifying section 12A in the step S104 and (ii) outputs the generated recommended company information by transmitting the recommended company information to the user terminal 3A. Specifically, the output section 13A, for example, generates screen data representing the recommended company(ies) and a degree of similarity of each of the recommended company(ies), and transmits the generated screen data to the user terminal 3A. In other words, the output section 13A transmits the generated image data to the user terminal 3A, thereby displaying each of the recommended company(ies) on a display apparatus in a display mode corresponding to the degree of similarity. Examples of displaying each of the recommended company(ies) in a display mode corresponding to the degree of similarity include (i) displaying a plurality of recommended companies such that the plurality of recommended companies are sorted by degrees of similarity, (ii) displaying each recommended company such that a color, shape, and/or the like of information representing the recommended company differ(s) depending on the degree of similarity of the recommended company, and (iii) displaying a figure (graph etc.) representing the degree of similarity of each recommended company.

(Step S106)

In the step S106, the displaying section 32 of the user terminal 3A displays the recommended company information on the display apparatus. Specifically, the displaying section 32 displays, on the display apparatus, an image represented by the screen data received from the recommendation apparatus 10A. An example screen displayed on the user terminal 3A in the present step will be described below.

<Example Screen>

FIG. 9 is an example screen G11 in which a recommended company is displayed. In the example illustrated in FIG. 9, the example screen G11 includes (i) company names of companies B to F, which are recommended companies of a company A, which is a target company and (ii) a degree of coincidence between the company A, which is a target company, and each of the recommended companies. The “degree of coincidence” may be the same as the “degree of similarity”, or may be calculated by the specifying section 12A on the basis of the degree of similarity. The degree of coincidence may be, for example, a representation, in the form of a numerical value of 0 to 100, of an extent to which the target company and a recommended company are similar to each other.

Further, the displaying section 32, in the example screen G11, displays the respective company names of the recommended companies and the respective degrees of coincidence of the recommended companies such that (i) the company name of each recommended company and the degree of coincidence of the each recommended company are associated with each other and (ii) the company names of the recommended companies are sorted in descending order or ascending order of degrees of coincidence. Thus, in the example illustrated in FIG. 9, the output section 13A generates screen data representing a screen including a list in which the company name of each recommended company and the degree of coincidence of the each recommended company are associated with each other and the company names of the recommended companies are sorted in descending order or ascending order of degrees of coincidence.

In a case where the recommended companies are displayed in the example screen G11, the user can recognize the recommended companies, which are matching candidates of the target company designated by the user. Further, in a case where the recommended companies are sorted by degrees of coincidence and displayed in ranks of degrees of coincidence in the example screen G11, it is easy to know a recommended company more suitable as a cooperation partner of the target company.

In a case where an attempt is made to specify a recommended company with use of an entire need text, a description part which is not directly related to a need of a company may serve as noise and prevent properly specifying a recommended company. In the present example embodiment, however, the recommendation system 1A uses a core phrase extracted on the basis of an extraction condition. This makes it easy to reduce an effect of noise in a process of specifying a recommended company.

<Example Advantage of Present Example Embodiment>

As described above, according to the present example embodiment, the recommendation system 1A (i) extracts core phrases respectively from a need text of a target company and a need text of a cooperation candidate company with use of the keyword dictionary DB3 and (ii) specifies a recommended company on the basis of the core phrases extracted. By specifying the recommended company on the basis of the core phrases extracted from the need texts with use of the keyword dictionary DB3 rather than specifying the recommended company on the basis of the entire need text, the recommendation system 1A easily presents a more suitable recommended company to a user.

Further, since the recommendation system 1A displays a specified recommended company with use of a degree of similarity, it is easy for a user to know a degree of matching between each recommended company and the target company.

### Fourth Example Embodiment

The following will discuss in detail a fourth example embodiment of the present invention, with reference to drawings. Note that any constituent element that is identical in function to a constituent element described in any one(s) of the first to third example embodiments will be given the same reference numeral, and a description thereof will not be repeated.

<Configuration of Recommendation System>

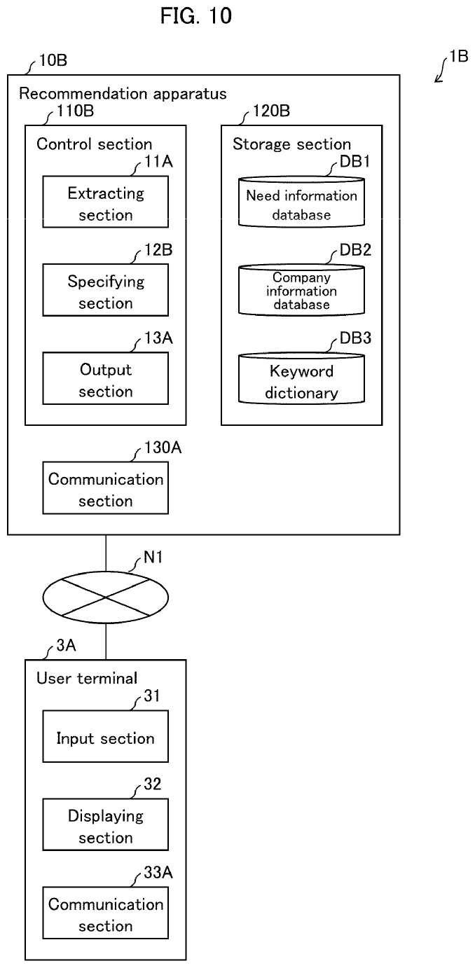

A recommendation system 1B in accordance with the present example embodiment is an example aspect obtained by modifying the third example embodiment. The recommendation system 1B presents to a user, as a recommended company recommended as a matching candidate of a target company, a company that is highly unlikely to compete with the target company. The following will discuss a configuration of the recommendation system 1B, with reference to FIG. 10. FIG. 10 is a block diagram illustrating a configuration of the recommendation system 1B.

As illustrated in FIG. 10, the recommendation system 1B is configured substantially similarly as the recommendation system 1A in accordance with the third example embodiment, and differs from the recommendation system 1A in including a recommendation apparatus 10B in place of the recommendation apparatus 10A. In other respects, the recommendation system 1B is configured similarly as the recommendation system 1A.

(Configuration of Recommendation Apparatus)

As illustrated in FIG. 10, the recommendation apparatus 10B includes a control section 110B, a storage section 120B, and a communication section 130A. The control section 110B is configured substantially similarly as the control section 110A in accordance with the third example embodiment, and differs from the control section 110A in including a specifying section 12B in place of the specifying section 12A. In other respects, the control section 110B is configured similarly as the control section 110A.

The storage section 120B is configured similarly as the storage section 120A in accordance with the third example embodiment, and further includes a company information database DB2.

(Company Information Database)

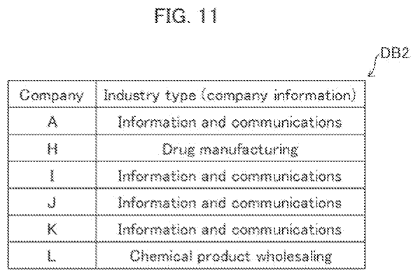

The following will discuss a configuration of the company information database DB2, with reference to FIG. 11. FIG. 11 is a view illustrating a specific example of the company information database DB2. The company information database DB2 is a database in which industry types of a plurality of companies are registered. As illustrated in FIG. 11, the company information database DB2 stores therein pieces of company information including the respective industry types of the plurality of companies. In an example illustrated in FIG. 11, information indicative of an industry type “information and communications” is stored as company information of each of companies A, I, J, and K. As company information of a company H, information indicative of an industry type “drug manufacturing” is stored. As company information of a company L, information indicative of an industry type “chemical product wholesaling” is stored. Note that company information can include, in place of or in addition to information indicative of industry type, other information pertaining to the company.

The specifying section 12B specifies, as a recommended company, a company other than a competitor company of a target company, with reference to pieces of company information of cooperation candidate companies stored in the company information database DB2. A competitor company is a company that is highly likely to compete with the target company. Examples of a competitor company include a company whose industry type is the same as that of the target company or a company whose industry type is similar to that of the target company. Details of a process of specifying a recommended company will be described later.

<Flow of Recommendation Method>

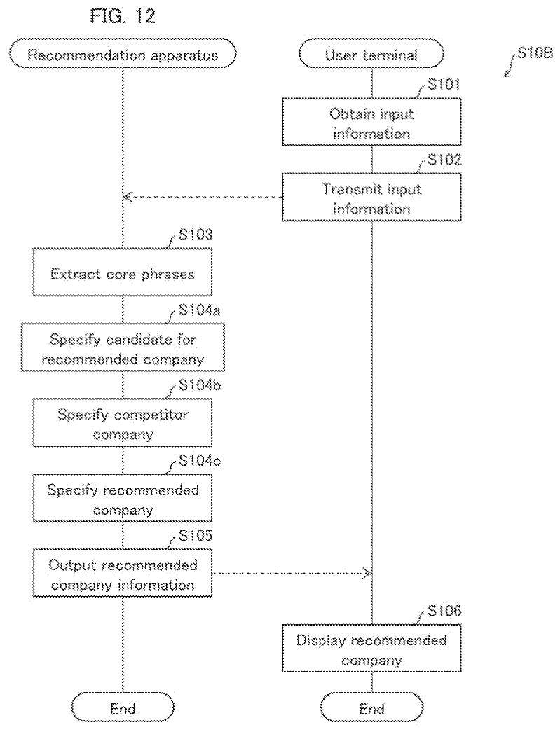

The following will discuss, with reference to FIG. 12, a flow of a recommendation method S10B carried out by the recommendation system 1B configured as described above. FIG. 12 is a flowchart illustrating a flow of the recommendation method S10B. As illustrated in FIG. 12, the recommendation method S10B is configured substantially similarly as the recommendation method S10A in accordance with the third example embodiment, and differs from the recommendation method S10A in including steps S104a to S104c in place of the step S104. The following description will discuss the steps S104a to S104c. The other steps are similar to those of the recommendation method S10A, and detailed descriptions thereof will not be repeated.

(Step S104a)

In the step S104a, the specifying section 12B of the recommendation apparatus 10B extracts, as a candidate(s) for a recommended company, one or more cooperation candidate companies each of which has a core phrase similar to that of the target company. Details of a process by which the specifying section 12B specifies a candidate(s) for a recommended company in this step are similar to the details of the process of specifying a recommended company in the step S104 in accordance with the third example embodiment, and detailed descriptions thereof will not be repeated.

(Step S104b)

In the step S104b, the specifying section 12B refers to the company information database DB2 and specifies one or more competitor companies, each of which competes with the target company, among the candidate(s) for a recommended company. For example, the specifying section 12B refers to the company information database DB2, and on the basis of company information including an industry type of a cooperation candidate company, specifies, as a competitor company, a company whose industry type corresponds to an industry type of the target company. Examples of the company whose industry type corresponds to the industry type of the target company include a company whose industry type is the same as that of the target company or a company whose industry type is similar to that of the target company.

(Specific Example of Process of Specifying Competitor Company)

Specifically, the specifying section 12B refers to the company information database DB2 and specifies, as a competitor company, a company whose industry type is the same as that of the target company among the candidate(s) for a recommended company. For example, in the example of the company information database DB2 illustrated in FIG. 11, it is assumed that the companies H, I, J, K, and L have been specified as candidates for a recommended company of the company A. In this case, the specifying section 12B specifies, as competitor companies, the companies I, J, and K whose industry types are the same as the industry type of the company A, namely, “information communications”, among the candidates for a recommended company.

Note that a method of specifying a competitor company with reference to company information is not limited to this method. For example, the specifying section 12B may use a trained model that has been trained to output a degree of competition upon receiving input of respective pieces of company information of two companies. In this case, the specifying section 12B inputs, to the trained model, company information of a target company and company information of a candidate for a recommended company, and specifies, as a competitor company, a candidate for which a degree of competition not less than a threshold is outputted.

Further, the specifying section 12B may refer to the company information database DB2 and specify, as a competitor company, a company whose industry type is similar to that of the target company. In this case, for example, similar industry type information, which indicates a group of industry types similar to one another, may be stored in advance in the storage section 120B of the recommendation apparatus 10B, and the specifying section 12B may specify, as a competitor company, a company whose industry type is similar to that of the target company, with use of the similar industry type information stored in the storage section 120B.

(Step S104c)

In the step S104c, the specifying section 12B excludes the competitor company(ies) from the candidate(s) for a recommended company and considers the remaining company to be a recommended company. In other words, the specifying section 12B specifies, as a recommended company, a company other than the competitor company(ies) among the candidate(s) for a recommended company.

Subsequently, the recommendation system 1B displays the recommended company on a display apparatus of a user terminal 3A by carrying out steps S105 and S106.

<Example Advantage of Present Example Embodiment>

As described above, according to the present example embodiment, the recommendation apparatus 10B does not specify, as a recommended company, a company that is highly likely to compete with a target company, even if the company has a core phrase similar to that of the target company. This allows the recommendation apparatus 10B to present a more suitable recommended company to a user.

In the example embodiment described above, a configuration has been described in which the need information database DB1 and the company information database DB2 are separate databases. The configuration of databases is not limited to the one indicated in the above example embodiment. Need texts and company information may be stored in a single database. In other words, company information stored in the company information database DB2 may include a need text and information pertaining to industry type. In this case, company information of each company stored in the company information database DB2 is an example of “target company information” and “cooperation candidate company information” recited in Claims. In this case, the specifying section 12B specifies, as a competitor company, a company whose industry type corresponds to an industry type of the target company, on the basis of company information including an industry type of a cooperation candidate company (cooperation candidate company information).

### Fifth Example Embodiment

The following will discuss in detail a fifth example embodiment of the present invention, with reference to drawings. Note that any constituent element that is identical in function to a constituent element described in any one(s) of the first to fourth example embodiments will be given the same reference numeral, and a description thereof will not be repeated.

<Configuration of Recommendation System>

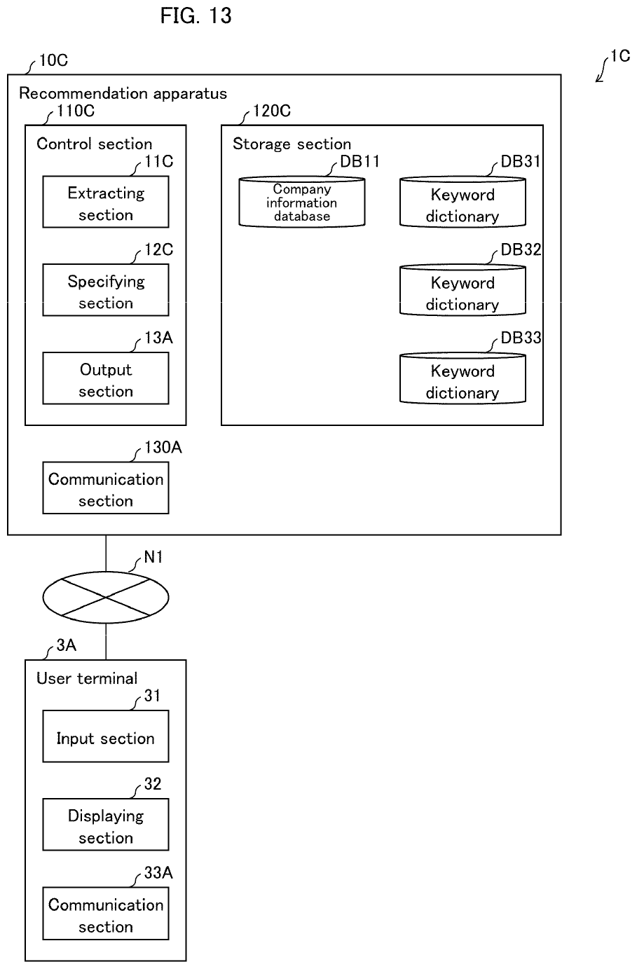

The following will discuss a configuration of a recommendation system 1C in accordance with the present example embodiment, with reference to FIG. 13. FIG. 13 is a block diagram illustrating a configuration of the recommendation system 1C. The recommendation system 1C is an example aspect obtained by modifying the fourth example embodiment. The recommendation system 1C specifies a cooperation candidate company with use of a plurality of keyword dictionaries. As illustrated in FIG. 13, the recommendation system 1C includes a recommendation apparatus 10C in place of the recommendation apparatus 10B of the recommendation system 1B in accordance with the fourth example embodiment.

(Configuration of Recommendation Apparatus)

The recommendation apparatus 10C includes a control section 110C, a storage section 120C, and a communication section 130A. The control section 110C includes an extracting section 11C and a specifying section 12C in place of the extracting section 11A and the specifying section 12B of the control section 110C. The storage section 120C stores therein a company information database DB11 and keyword dictionaries DB31 to DB33 in place of the company information database DB1 and the keyword dictionary DB3.

The company information database DB11 stores therein company information including a cooperation detail desired by a company. The company information is, for example, target company information or cooperation candidate company information in this specification. The company information includes, for example, a text describing the company or a text representing a need of the company. The company information may be, for example, a need text in accordance with the above-described fourth example embodiment, a text included in a company website of the company, or a text included in a website explaining or describing the company. Registration of the company information in the company information database DB11 is carried out by, for example, an administrator of the recommendation apparatus 10C.

The keyword dictionaries DB31 to DB33 are each a list in which one or more words each used as a keyword in a process of extracting a core phrase are registered, similarly as the keyword dictionary DB3. The keyword dictionaries DB31 to DB33 are an example of a plurality of dictionaries in this specification.

All or part of the registered keyword(s) is/are different among the keyword dictionaries DB31 to DB33. For example, one of the plurality of keyword dictionaries is a list of keywords that are highly likely to be included in a text representing a need of a company. The keywords that are highly likely to be included in a need text of a company are, for example, words such as “seek,” “search,” “buy,” and “sell.”

Further, one of the plurality of keyword dictionaries may be, for example, a list in which keywords related to corporate culture are registered.

Further, one of the plurality of keyword dictionaries may be a list of keywords that are related to an industry type of a company. In this case, a keyword dictionary may be provided for each industry type. In this case, for example, the extracting section 11C may select a keyword dictionary corresponding to an industry type of a target company and use the keyword dictionary in a process of extracting a core phrase.

The extracting section 11C extracts core phrases for the respective keyword dictionaries DB31 to DB33 with use of the keyword dictionaries DB31 to DB33. The specifying section 12C specifies a recommended company on the basis of the core phrases extracted for the respective keyword dictionaries DB31 to DB33. Details of a process of specifying a recommended company will be described later.

<Flow of Recommendation Method>

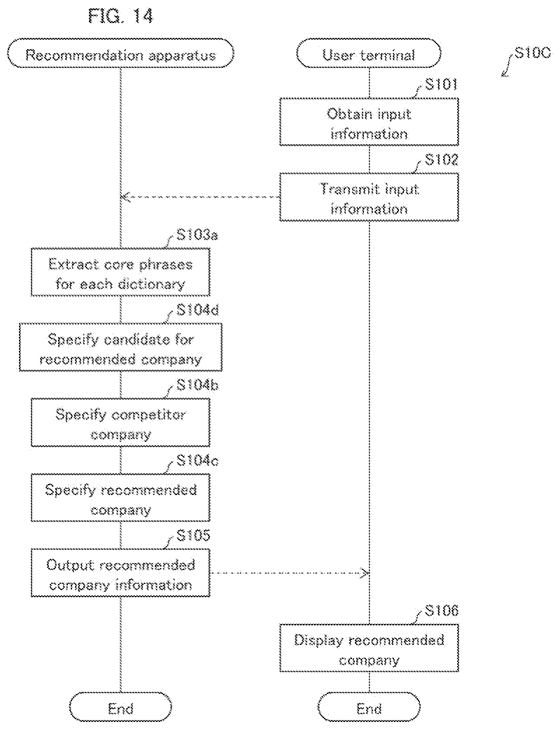

The following will discuss, with reference to FIG. 14, a flow of a recommendation method S10C carried out by the recommendation system 1C configured as described above. FIG. 14 is a flowchart illustrating a flow of the recommendation method S10C. As illustrated in FIG. 14, the recommendation method S10C includes steps S103a and S104d in place of the steps S103 and S104a of the recommendation method S10B in accordance with the fourth example embodiment. The following description will discuss the step S103a and the step S104d. The other steps are similar to those of the recommendation method S10B, and detailed descriptions thereof will not be repeated.

(Step S103a)

In the step S103a, the extracting section 11C of the recommendation apparatus 10C extracts core phrases for the respective keyword dictionaries DB31 to DB33 with use of the keyword dictionaries DB31 to DB33. Specifically, the extracting section 11C extracts a first core phrase(s) from the company information with use of the keyword dictionary DB31. The extracting section 11C also extracts a second core phrase(s) from the company information with use of the keyword dictionary DB32. Further, the extracting section 11C extracts a third core phrase(s) from the company information with use of the keyword dictionary DB33. Thus, the extracting section 11C extracts three types of core phrases from the company information: the first core phrase(s), the second core phrase(s), and the third core phrase(s).

(Step S104d)

In the step S104d, the specifying section 12C specifies a candidate for a recommended company on the basis of the first core phrase(s), the second core phrase(s), and the third core phrase(s) extracted for the respective keyword dictionaries DB31 to DB33.

For example, the specifying section 12C calculates degrees of similarity between the target company and a cooperation candidate company on the basis of the first core phrase(s), the second core phrase(s), and the third core phrase(s) extracted by the extracting section 11C, and specifies a candidate for a recommended company with use of the calculated degrees of similarity. In this case, for example, the specifying section 12C calculates a distance between core phrases for each of the keyword dictionaries DB31 to DB33 and specifies a recommended company with use of a result of the calculation for each of the dictionaries. Details of a method of calculating a distance between core phrases carried out by the specifying section 12C are similar to the details of the process described in the step S104 in accordance with the third example embodiment, and detailed descriptions thereof will not be repeated.

For example, the specifying section 12C calculates a degree of similarity between core phrases for each of the keyword dictionaries DB31 to DB33 with use of the distance between the core phrases calculated for each of the dictionaries, and specifies a candidate for a recommended company on the basis of a statistical value of degrees of similarity for the respective keyword dictionaries DB31 to DB33. For example, the specifying section 12C may calculate, for each cooperation candidate company, an average value of degrees of similarity for the respective dictionaries, and specify, as a recommended company(ies), one or more cooperation candidate companies for each of which the calculated average value is not less than a threshold.

Further, for example, the specifying section 12C may calculate, for each cooperation candidate company, a value obtained by weighting a degree of similarity for each dictionary, and specify, as a recommended company(ies), one or more cooperation candidate companies for each of which the calculated value is not less than a threshold. A weighting coefficient used in weighting the degree of similarity for each dictionary may be preset by, for example, an administrator of the recommendation apparatus 10C. Further, for example, the specifying section 12C may specify the weighting coefficient for each dictionary on the basis of at least one of a core phrase of the target company and a core phrase of the recommended company. For example, the specifying section 12C may determine the weighting coefficient for each dictionary such that the larger the number of keywords included in a core phrase, the greater the weighting. Further, a user of a user terminal 3A may set the weighting coefficient for each dictionary via an input apparatus.

<Example Advantage of Present Example Embodiment>

As described above, according to the present example embodiment, the recommendation apparatus 10C extracts core phrases with use of the plurality of keyword dictionaries DB31 to DB33 and specifies a recommended company on the basis of the core phrases extracted for the respective dictionaries. By using the plurality of types of keyword dictionaries, more diverse recommended companies can be presented to a user.

In the above-described example embodiment, the target company information can be stored in advance in the company information database DB11, or the extracting section 11C can obtain the target company information from another apparatus. For example, a user of the user terminal 3A may input the target company information with use of an input apparatus. In this case, for example, the user terminal 3 transmits, to the recommendation apparatus 10C, input information which includes (i) identification information for identifying a target company and (ii) target company information. The recommendation apparatus 10C may receive the input information from the user terminal 3 and extract a core phrase from the target company information included in the received input information.

In the above-described example embodiment, the extracting section 11C extracts core phrases with use of the respective keyword dictionaries DB31 to DB33. The extracting section 11C may select one or more dictionaries among the plurality of dictionaries stored in the storage section 120C and use the selected one or more dictionaries in a process of extracting a core phrase. Various methods can be employed as a method of selecting a dictionary. For example, the extracting section 11C may (i) cause a user to select a dictionary by, for example, displaying a list of keyword dictionaries on a display apparatus via the user terminal 3A and (ii) select, in accordance with a result of selection by the user, a dictionary to be used. Further, for example, the extracting section 11C may select a dictionary that is associated with an industry type of a target company or a recommended company.

### Sixth Example Embodiment

The following will discuss in detail a sixth example embodiment of the present invention, with reference to drawings. Note that any constituent element that is identical in function to a constituent element described in any one(s) of the first to fifth example embodiments will be given the same reference numeral, and a description thereof will not be repeated.

<Configuration of Recommendation System>

A recommendation system 1D in accordance with the present example embodiment is an example aspect obtained by modifying the third example embodiment. The recommendation system 1D presents, to a user, a correspondence between a first important part in target company information and a second important part in cooperation candidate company information of a recommended company, as well as presenting the recommended company to the user.

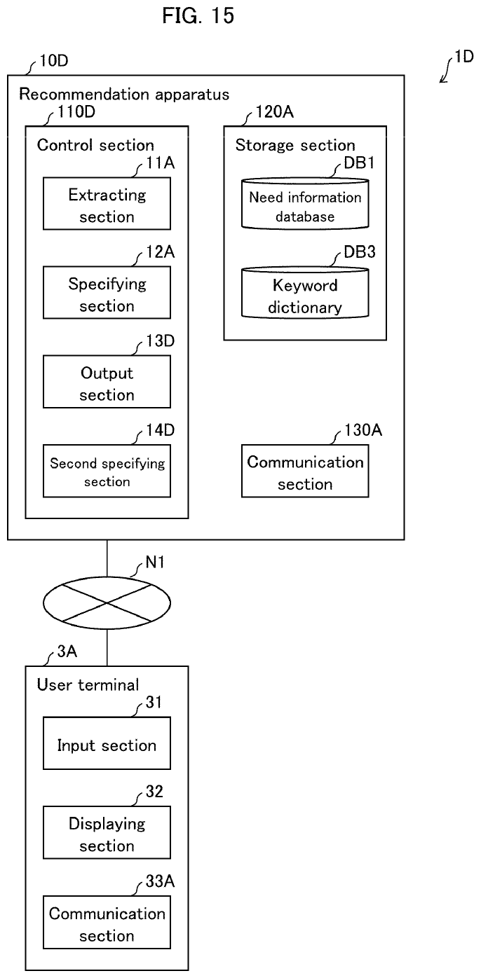

The following will discuss a configuration of the recommendation system 1D, with reference to FIG. 15. FIG. 15 is a block diagram illustrating a configuration of the recommendation system 1D. The recommendation system 1D includes a recommendation apparatus 10D in place of the recommendation apparatus 10A of the recommendation system 1A in accordance with the third example embodiment described above.

(Configuration of Recommendation Apparatus)

The recommendation apparatus 10D includes a control section 110D, a storage section 120A, and a communication section 130A. The control section 110D includes an output section 13D in place of the output section 13A of the control section 110A in accordance with the third example embodiment and further includes a second specifying section 14D.

(Configuration of Second Specifying Section)

The second specifying section 14D specifies, from a need text of a target company and a need text of a recommended company each, a phrase related to a business in which the target company seeks cooperation (hereinafter, may be referred to as an “important phrase”). That is, the second specifying section 14D specifies a first important part in the need text of the target company and a second important part in the need text of the recommended company. Note that the first important part and the second important part are each an important phrase. The second specifying section 14D can specify a single first important part or a plurality of first important parts. Further, the second specifying section 14D can specify a single second important part or a plurality of second important parts. The need text of the target company is an example of target company information in this specification. The need text of the recommended company is an example of cooperation candidate company information in this specification. The second specifying section 14D also specifies a correspondence between each first important part and each second important part. Details of a method of specifying each first important part, each second important part, and a correspondence therebetween will be described later.

(Configuration of Output Section)

The output section 13D presents a recommendation result to a user terminal 3A on the basis of a correspondence specified by the second specifying section 14D. The recommendation result includes, in addition to the recommended company information in the third example embodiment, information indicative of a correspondence between a first important part and a second important part.

<Flow of Recommendation Method>

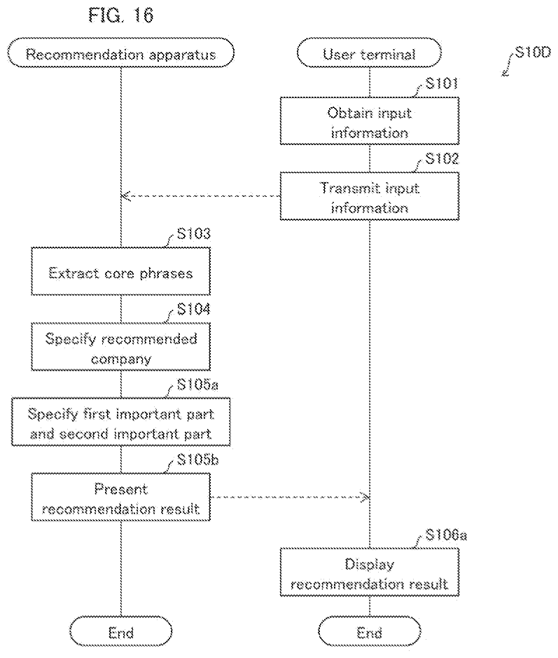

The following will discuss, with reference to FIG. 16, a flow of a recommendation method S10D carried out by the recommendation system 1D configured as described above. FIG. 16 is a flowchart illustrating a flow of the recommendation method S10D. As illustrated in FIG. 16, the recommendation method S10D includes steps S105a, S105b, and S106a in place of the steps S105 and S106 of the recommendation method S10A in accordance with the third example embodiment. The following description will discuss the steps S105a, S105b, and S106a. The other steps are similar to those of the recommendation method S10A, and detailed descriptions thereof will not be repeated.

(Step S105a)

In the step S105a, the second specifying section 14D specifies at least one first important part in the need text of the target company and at least one second important part in a need text of each recommended company. The second specifying section 14D also specifies a correspondence between each first important part and each second important part. Note that in order to specify the “correspondence between each first important part and each second important part”, the second specifying section 14D specifies, out of combinations of a first important part and a second important part, a combination of a first important part and a second important part having a correspondence therebetween.

Note that a method of specifying each first important part, each second important part, and a correspondence therebetween can specifically be, for example, a (d) method based on interword distances, a (e) method based on levels of importance of words, or a (f) method based on a part to which a trained model pays attention. Details of these methods will be described below. Note that the method of specifying each first important part, each second important part, and a correspondence therebetween is not limited to these examples.

(d: Method Based on Interword Distances)

This method is preferably applied in a case where a specifying section 12A uses the “(a) method based on interword distances” in a step S104. In a case where this method is employed, the second specifying section 14D specifies each first important part and each second important part in the need text of the recommended company on the basis of an interword distance between each word included in the need text of the target company and each word included in the need text of the recommended company. In so doing, the second specifying section 14D may refer to, as an interword distance of each combination of words, a value calculated by the specifying section 12A in the method (a).

For example, the second specifying section 14D determines that, in a combination of words having an interword distance not more than a threshold, the word included in the need text of the target company is an important word in the need text of the target company. The second specifying section 14D also determines that, in the combination of words having the interword distance not more than the threshold, the word included in the need text of the recommended company is an important word in the need text of the recommended company.

Further, for example, the second specifying section 14D calculates, for each constituent unit of the need text of the target company, a score based on an important word included in the each constituent unit, and determines that a constituent unit whose score thus calculated is not less than a threshold is a first important part. Further, for example, the second specifying section 14D calculates, for each constituent unit of the need text of the recommended company, a score based on an important word included in the each constituent unit, and determines that a constituent unit whose score thus calculated is not less than a threshold is a second important part. Note that specific examples of a constituent unit include, but are not limited to, a phrase or a paragraph. Specific examples of a score include, but are not limited to, a value based on the number of important words included.

Further, the second specifying section 14D specifies, as a combination of a first important part and a second important part having a correspondence therebetween from among combinations of a first important part and a second important part, a combination whose statistical value of interword distances between important words contained in the combination is not more than a threshold.

(e: Method Based on Levels of Importance of Words)

This method is preferably applied in a case where the specifying section 12A uses the “(b) method based on an inter-document distance” or the “(c) method based on a trained model” in the step S104.

In a case where this method is employed, the second specifying section 14D specifies each first important part and each second important part on the basis of a level of importance of each word included in each of the need text of the target company and the need text of the recommended company. For example, the second specifying section 14D calculates, for each constituent unit of the need text of the target company, a score on the basis of a level of importance of each word included in the each constituent unit, and determines that a constituent unit whose score thus calculated is not less than a threshold is a first important part. Further, for example, the second specifying section 14D calculates, for each constituent unit of the need text of the recommended company, a score on the basis of a level of importance of each word included in the each constituent unit, and determines that a constituent unit whose score thus calculated is not less than a threshold is a second important part.

In a case where a single first important part and a single second important part are specified, the second specifying section 14D specifies the single first important part and the single second important part as having a correspondence therebetween.

In a case where a plurality of first important parts and/or a plurality of second important parts are specified, the second specifying section 14D can regard each of the plurality of first important parts as a document and each of the plurality of second important parts as a document, and calculate an inter-document distance. In this case, the second specifying section 14D specifies, as a combination of a first important part and a second important part having a correspondence therebetween from among combinations of a first important part and a second important part, a combination having an inter-document distance not more than a threshold.

Note that specific examples of a technique for calculating a level of importance of a word included in each need text include, but are not limited to, term frequency-inverse document frequency (TF-IDF). In a case where TF-IDF is used, a level of importance of a word included in a certain need text is calculated such that the level of importance increases as the word appears in the certain need text more frequently and as the word occurs only in a smaller number of need texts, including the certain need text, among a plurality of need texts.

(f: Method Based on Part to which Trained Model Pays Attention)

This method is preferably applied in a case where the specifying section 12A uses the “(b) method based on an inter-document distance” or the “(c) method based on a trained model” in the step S104.

In a case where this method is employed, the second specifying section 14D specifies each first important part and each second important part on the basis of a part to which the trained model used in the “(b) method based on an inter-document distance” or the “(C) method based on a trained model” pays attention in each of an inputted need text of the target company and an inputted need text of the recommended company.

Specifically, the second specifying section 14D determines, with use of an attention mechanism incorporated in the trained model, a degree of attention paid to each word included in each of the need texts inputted. Further, the specifying section 12A calculates, for each constituent unit of the need text of the target company, a score based on a degree of attention paid to a word included in the each constituent unit, and determines that a constituent unit whose score thus calculated is not less than a threshold is a first important part. Further, the specifying section 12A calculates, for each constituent unit of the need text of the recommended company, a score based on a degree of attention paid to a word included in the each constituent unit, and determines that a constituent unit whose score thus calculated is not less than a threshold is a second important part.

A method of specifying a correspondence in a case where a single first important part and a single second important part are specified is as described in “(e): Method based on levels of importance of words”. Further, a method of specifying a correspondence in a case where a plurality of first important parts and/or a plurality of second important parts are specified is as described in “(e): Method based on levels of importance of words”.

(Step S105b)

In the step S105b, the output section 13D presents a recommendation result to the user terminal 3A. The recommendation result includes information indicative of a recommended company, a first important part, a second important part, and information indicative of a correspondence between the first important part and the second important part. Specifically, the output section 13D generates screen data indicating the recommendation result. The output section 13D outputs the recommendation result to the user terminal 3A by transmitting the screen data to the user terminal 3A.

Specifically, the output section 13D generates screen data including the need text of the target company and the need text of the recommended company. In the need text of the target company included in the screen data, the output section 13D causes a difference between a display mode of the first important part and a display mode of a part other than the first important part. In the need text of the recommended company included in the screen data, the output section 13D causes a difference between a display mode of the second important part and a display mode of a part other than the second important part. The output section 13D may cause a display mode of the first important part and a display mode of the second important part to correspond to each other in the screen data. Specifically, to each combination of a first important part and a second important part having a correspondence therebetween, the output section 13D may apply a display mode that differs among such combinations. Details of such screen data will be described later.

(Step S106a)

In the step S106a, a displaying section 32 of the user terminal 3A displays the recommendation result outputted from the recommendation apparatus 10D. Specifically, the displaying section 32 displays, on the display apparatus, the screen data received from the recommendation apparatus 10D. An example screen displayed on the user terminal 3A in the present step will be described below.

<Example Screen>

The following will discuss, with reference to FIG. 17, an example screen displayed by the recommendation system 1D in the step S106a. FIG. 17 illustrates an example screen G1 of the recommendation result. As illustrated in FIG. 17, the example screen G1 includes a need text A of a company A, which is a target company, and need texts H, I, and L of companies H, I, and L, which are recommended companies.

In the need text A of the company A, first important parts p1 to p3 are specified. In the need text H of the company H, a second important part p4 is specified. In the need text I of the company I, a second important part p5 is specified. In the need text L of the company L, a second important part p6 is specified. The first important parts p1 to p3 and the second important parts p4 to p6 are each displayed in a display mode different from display modes of the other paragraphs of a corresponding need text. In this example, a display mode in which an important part is enclosed by a rectangle is applied to important parts. The present example embodiment, however, is not limited to such a display mode. For example, the first important parts p1 to p3 and the second important parts p4 to p6 can each be displayed in a display mode that is (i) any one selected from the group consisting of: a color different from that of the other part of a corresponding need text; a background color different from that of the other part of the corresponding need text; a font different from that of the other part of the corresponding need text; a size different from that of the other part of the corresponding need text; a luminance different from that of the other part of the corresponding need text; boldfacing; italicizing; underlining; blinking; and animation or (ii) a combination of at least two selected from the group.

Note that in the example screen G1, the display mode applied may differ among combinations of a first important part and a second important part in each of which the first important part and the second important part have a correspondence therebetween. For example, a rectangle enclosing the first important part p1 and a rectangle enclosing the second important part p4 may be red, a rectangle enclosing the first important part p2 and a rectangle enclosing the second important part p5 may be blue, and a rectangle enclosing the first important part p3 and a rectangle enclosing the second important part p6 may be yellow. Note that the present example embodiment is not limited to such a configuration of the display mode differing among combinations of a first important part and a second important part in each of which the first important part and the second important part have a correspondence therebetween. For example, the display modes applied to the respective combinations can be: any one of respective different background colors, respective different fonts, respective different sizes, or respective different luminances; a combination of at least two thereof, or the like.

Boldfaced words in the need texts A, H, I, and L are words specified as important words in corresponding need texts. An important word is thus displayed in a display mode different from those of the other words. Note, however, that the display mode applied to an important word is not limited to boldfacing. For example, an important word can be displayed in a display mode that is (i) any one selected from the group consisting of: a color different from that of the other words; a background color different from that of the other words; a font different from that of the other words; a size different from that of the other words; a luminance different from that of the other words; italicizing; underlining; blinking; animation; and framing or (ii) a combination of at least two selected from the group.

The example screen G1 includes figures f1 to f3 each of which indicates a correspondence between a first important part and a second important part. In this example, the figures f1 to f3 are each a two-headed arrow. Note, however, that the figures f1 to f3 are each not limited to a two-headed arrow. For example, the figures f1 to f3 may each be a line other than an arrow, such as a broken line, a dot-dash line, a double line, a curve, or a free line. The figure f1 indicates that the first important part p1 and the second important part p4 have a correspondence therebetween. The figure f2 indicates that the first important part p2 and the second important part p5 have a correspondence therebetween. The figure f3 indicates that the first important part p3 and the second important part p6 have a correspondence therebetween.

The user can recognize, from the figure f1, that the second important part p4 in the need text H corresponds to the first important part p1 in the need text A of the company A. The user can also recognize, from the figure f2, that the second important part p5 in the need text I corresponds to the first important part p2 in the need text A. In this example, the first important parts p1 and p2 in the need text A each indicate a business policy of the company A and do not sufficiently represent a desired feature of a cooperation partner of the company A. In this case, the user can easily determine that the companies H and I, which include the second important parts p4 and p5 corresponding to the first important parts p1 and p2, have low validity as a cooperation partner of the company A.

The user can also recognize, from the figure f3, that the second important part p6 in the need text L corresponds to the first important part p3 in the need text A of the company A. The first important part p3 in the need text A sufficiently represents a desired feature of a cooperation partner of the company A. In this case, the user can easily determine that the company L, which includes the second important part p6 corresponding to the first important part p3, has high validity as a cooperation partner of the company A.

Note that in the above-described case where differing display modes are applied to respective combinations of a first important part and a second important part in each of which the first important part and the second important part have a correspondence therebetween, the example screen G1 need not include the figures f1 to f3. In this case, the user can easily recognize a correspondence between a first important part and a second important by visually recognizing the second important part in a display mode corresponding to a display mode of the first important part.

<Example Advantage of Present Example Embodiment>

As described above, according to the present example embodiment, the recommendation apparatus 10D includes, in a recommendation result, information indicative of a correspondence between each first important part and each second important part, and outputs the recommendation result to the user terminal 3A. This allows a user to recognize which part of a need text of a target company corresponds to which part of a need text of a recommended company. As a result, the user can determine that a recommended company corresponding to a first important part that is included in the need text of the target company and more sufficiently represents a desired feature of a cooperation partner has higher validity as a cooperation partner. The user can also determine that a recommended company corresponding to a first important part that is included in the need text of the target company and does not sufficiently represent a desired feature of a cooperation partner has low validity. Thus, with use of the present example embodiment, a user can more easily determine validity of a recommended company.

In the present example embodiment, the output section 13D generates screen data representing the example screen G1 illustrated in FIG. 17. Screen data indicating a recommendation result and generated by the output section 13D is not limited to the example described above. For example, the output section 13D may (i) generate screen data that represents the example screen G11 illustrated in FIG. 9 and including the list of company names of recommended companies and (ii) transmit the screen data to the user terminal 3A so as to let a user select a recommended company. In this case, the user terminal 3A receives the screen data from the recommendation apparatus 10D and displays, on a display apparatus, the example screen G11 including the list of the company names of the recommended companies. The user selects one of the recommended companies from the displayed list. The user terminal 3A transmits, to the recommendation apparatus 10D, information representing the recommended company selected by the user. The recommendation apparatus 10D receives the information from the user terminal 3A, generates screen data representing a recommendation result for the recommended company represented by the received information, and transmits the screen data to the user terminal 3A.

[Software Implementation Example]

Some or all of the functions of the recommendation apparatuses 10, 10A, 10B, 10C, and 10D can be realized by hardware such as an integrated circuit (IC chip) or can be alternatively realized by software.

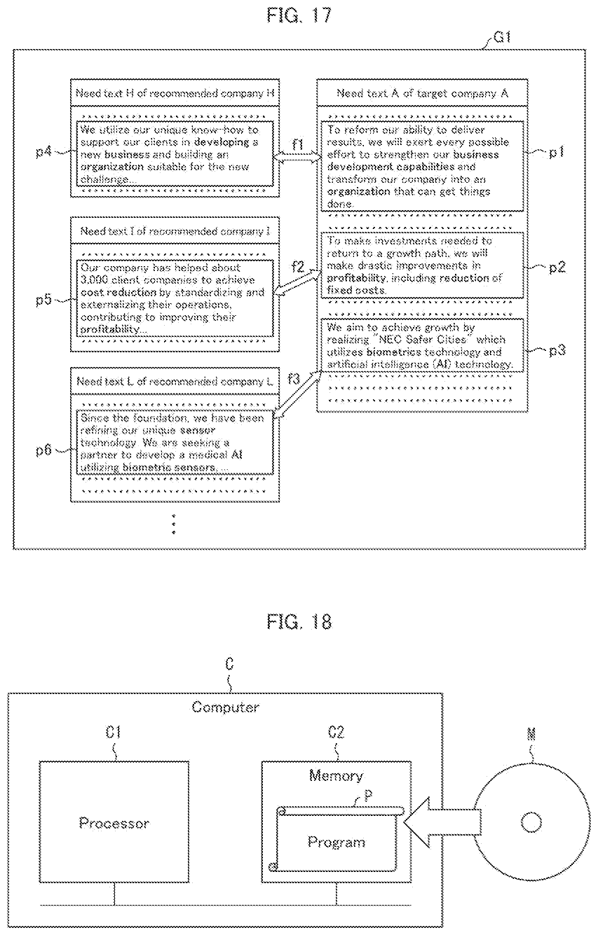

In the latter case, the recommendation apparatuses 10, 10A, 10B, and 10C are realized by, for example, a computer that executes instructions of a program that is software realizing the foregoing functions. FIG. 18 illustrates an example of such a computer (hereinafter, referred to as “computer C”). The computer C includes at least one processor C1 and at least one memory C2. The memory C2 stores a program P for causing the computer C to function as the recommendation apparatuses 10, 10A, 10B, 10C, and 10D. In the computer C, the processor C1 reads the program P from the memory C2 and executes the program P, so that the functions of the recommendation apparatuses 10, 10A, 10B, 10C, and 10D are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M that can be read by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

Some or all of the above example embodiments can be described as below. Note, however, that the present invention is not limited to example aspects described below.

(Supplementary Note 1)

A recommendation apparatus, including:
an extracting means that extracts, on the basis of a predetermined extraction condition, core phrases respectively from (i) target company information including a cooperation detail desired by a target company and (ii) cooperation candidate company information including a cooperation detail desired by a cooperation candidate company of the target company;
a specifying means that specifies a recommended company from among the cooperation candidate company on the basis of the core phrases extracted by the extracting means; and
an output means that outputs information indicative of the recommended company specified by the specifying means.

According to the above configuration, the recommendation apparatus (i) extracts the core phrases from the target company information and the cooperation candidate company information respectively, the target company information including the cooperation detail desired by the target company, the cooperation candidate company information including the cooperation detail desired by the cooperation candidate company of the target company and (ii) specifies a recommended company on the basis of the core phrases extracted. By specifying a recommended company on the basis of the core phrases extracted on the basis of the extraction condition, rather than specifying a recommended company on the basis of the entire target company information, it is possible to output information of a recommended company more suitable as a matching candidate.

(Supplementary Note 2)

The recommendation apparatus as set forth in supplementary note 1, wherein:
the specifying means calculates, on the basis of the core phrases extracted by the extracting means, a degree of similarity between the target company and the cooperation candidate company; and
the output means displays the recommended company on a display apparatus, in a display mode in accordance with the degree of similarity.

With the above configuration, a user can recognize an extent to which the target company and the cooperation candidate company are similar to each other. This makes it easy for the user to know a recommended company more suitable as a matching candidate.

(Supplementary Note 3)

The recommendation apparatus as set forth in supplementary note 2, wherein the specifying means calculates a distance between feature vectors related to the core phrases extracted by the extracting means, the distance being in a predetermined feature space, and calculates the degree of similarity on the basis of the distance calculated.

According to the above configuration, the recommendation apparatus can present, to the user, an extent to which the target company and the cooperation candidate company are similar to each other, by calculating the degree of similarity on the basis of the distance between the feature vectors related to the core phrases.

(Supplementary Note 4)

The recommendation apparatus as set forth in any one of supplementary notes 1 through 3, wherein the specifying means specifies, as the recommended company, a company other than a competitor company of the target company, with reference to company information of the cooperation candidate company.

With the above configuration, the recommendation apparatus does not present to the user, as a recommended company, a company that is highly likely to be a competitor company, even if the company has a core phrase similar to that of the target company. As such, the recommendation apparatus can present a more suitable matching candidate to the user, in comparison to a case where a competitor company is included among recommended companies.

(Supplementary Note 5)

The recommendation apparatus as set forth in supplementary note 4, wherein the specifying means specifies, as the competitor company, a company whose industry type corresponds to an industry type of the target company, on the basis of the cooperation candidate company information including an industry type of the cooperation candidate company.

According to the above configuration, the recommendation apparatus specifies, as the competitor company, a company whose industry type corresponds to an industry type of the target company, on the basis of the cooperation candidate company information. This makes it possible to present a more suitable matching candidate to the user, in comparison to a case where a competitor company is included among recommended companies.

(Supplementary Note 6)

The recommendation apparatus as set forth in any one of supplementary notes 1 through 5, wherein:
the extracting means extracts the core phrases for each of a plurality of dictionaries, the plurality of dictionaries storing therein a plurality of keywords respectively; and
the specifying means specifies the recommended company on the basis of the core phrases extracted for each of the plurality of dictionaries.

According to the above configuration, the recommendation apparatus specifies a recommended company on the basis of the core phrases extracted with use of the plurality of different dictionaries. This makes it possible to specify more diverse companies as recommended companies, in comparison to a case in which the plurality of dictionaries are not used.

(Supplementary Note 7)

The recommendation apparatus as set forth in any one of supplementary notes 1 through 6, wherein the specifying means calculates a distance between feature vectors related to the core phrases extracted by the extracting means, the distance being in a predetermined feature space, and specifies the recommended company on the basis of the distance calculated.

With the above configuration, the recommendation apparatus can output information indicative of a recommended company specified with use of a distance between core phrases.

(Supplementary Note 8)

The recommendation apparatus as set forth in supplementary note 7, wherein:
the extracting means extracts the core phrases for each of a plurality of dictionaries, the plurality of dictionaries storing therein a plurality of keywords respectively; and
the specifying means calculates the distance for each of the plurality of dictionaries and specifies the recommended company on the basis of a result of the calculation for each of the plurality of dictionaries.

According to the above configuration, the recommendation apparatus specifies a recommended company with use of a distance between core phrases extracted with use of the plurality of different dictionaries. This makes it possible to specify more diverse companies as recommended companies, in comparison to a case in which the plurality of dictionaries are not used.

(Supplementary Note 9)

The recommendation apparatus as set forth in any one of supplementary notes 1 through 8, further including a specifying means that specifies a first important part in the target company information and a second important part in cooperation candidate company information of the recommended company,
the output means presenting the information indicative of the recommended company, the first important part, and the second important part.

According to the above configuration, the recommendation apparatus includes, in a recommendation result, information indicative of a correspondence between each first important part and each second important part, and outputs the recommendation result to the user terminal. This allows a user to recognize which part of a need text of a target company corresponds to which part of a need text of a recommended company. The user can thus more easily determine validity of a recommended company.

(Supplementary Note 10)

A recommendation method, including:
extracting, on the basis of a predetermined extraction condition, core phrases respectively from (i) target company information including a cooperation detail desired by a target company and (ii) cooperation candidate company information including a cooperation detail desired by a cooperation candidate company of the target company;
specifying a recommended company from among the cooperation candidate company on the basis of the core phrases; and
outputting information indicative of the recommended company,
the extracting, the specifying, and the outputting being each carried out by a recommendation apparatus.

The above configuration makes it possible to obtain an effect similar to the effect of supplementary note 1.

(Supplementary Note 11)

A program for causing a computer to function as a recommendation apparatus,
the program causing the computer to function as:
an extracting means that extracts, on the basis of a predetermined extraction condition, core phrases respectively from (i) target company information including a cooperation detail desired by a target company and (ii) cooperation candidate company information including a cooperation detail desired by a cooperation candidate company of the target company;
a specifying means that specifies a recommended company from among the cooperation candidate company on the basis of the core phrases extracted by the extracting means; and
an output means that outputs information indicative of the recommended company specified by the specifying means.

The above configuration makes it possible to obtain an effect similar to the effect of supplementary note 1.

(Supplementary Note 12)

A storage medium storing therein a program for causing a computer to function as a recommendation apparatus,
the program causing the computer to function as:
an extracting means that extracts, on the basis of a predetermined extraction condition, core phrases respectively from (i) target company information including a cooperation detail desired by a target company and (ii) cooperation candidate company information including a cooperation detail desired by a cooperation candidate company of the target company;
a specifying means that specifies a recommended company from among the cooperation candidate company on the basis of the core phrases extracted by the extracting means; and
an output means that outputs information indicative of the recommended company specified by the specifying means.

The above configuration makes it possible to obtain an effect similar to the effect of supplementary note 1.

(Supplementary Note 13)

A recommendation system, including a recommendation apparatus and a user terminal,
the recommendation apparatus including:
   an extracting means that extracts, on the basis of a predetermined extraction condition, core phrases respectively from (i) target company information including a cooperation detail desired by a target company indicated by input information and (ii) cooperation candidate company information including a cooperation detail desired by a cooperation candidate company of the target company;
   a specifying means that specifies a recommended company from among the cooperation candidate company on the basis of the core phrases extracted by the extracting means; and
   an output means that outputs information indicative of the recommended company specified by the specifying means,
the user terminal including:
   an input means that obtains the input information; and
   a displaying means that displays the information outputted from the recommendation apparatus and indicative of the recommended company.

The above configuration makes it possible to obtain an effect similar to the effect of supplementary note 1.

[Additional Remark 3]

Further, some or all of the above example embodiments can also be described as below.

A recommendation apparatus, including at least one processor, the processor carrying out:
an extracting process of extracting, on the basis of a predetermined extraction condition, core phrases respectively from (i) target company information including a cooperation detail desired by a target company and (ii) cooperation candidate company information including a cooperation detail desired by a cooperation candidate company of the target company;
a specifying process of specifying a recommended company from among the cooperation candidate company on the basis of the core phrases extracted in the extracting process; and
an output process of outputting information indicative of the recommended company specified in the specifying process.

Note that the recommendation apparatus may further include a memory, which may store therein a program for causing the at least one processor to carry out the extracting process, the specifying process, and the outputting process. Further, the program can be stored in a non-transitory tangible storage medium that can be read by a computer.

### REFERENCE SIGNS LIST

10, 10A, 10B, 10C, 10D, 100: recommendation apparatus
1, 1A, 1B, 1C, 1D: recommendation system
3, 3A: user terminal
11, 11A, 101: extracting section
12, 12A, 12B, 12C, 102: specifying section
13, 13A, 103: output section
31: input section
32: displaying section

What is claimed is:

1. A recommendation apparatus, comprising at least one processor,
the at least one processor carrying out:
an extracting process of extracting, on the basis of a predetermined extraction condition, core phrases respectively from (i) target company information including a cooperation detail desired by a target company and (ii) cooperation candidate company information including a cooperation detail desired by a cooperation candidate company of the target company;
a specifying process of specifying a recommended company from among the cooperation candidate company on the basis of the core phrases extracted by the extracting process; and
an output process of outputting information indicative of the recommended company specified by the specifying process.

2. The recommendation apparatus as set forth in claim 1, wherein:
in the specifying process, the at least one processor calculates, on the basis of the core phrases extracted by the extracting process, a degree of similarity between the target company and the cooperation candidate company; and
in the output process, the at least one processor displays the recommended company on a display apparatus, in a display mode in accordance with the degree of similarity.

3. The recommendation apparatus as set forth in claim 2, wherein in the specifying process, the at least one processor calculates a distance between feature vectors related to the core phrases extracted by the extracting process, the distance being in a predetermined feature space, and calculates the degree of similarity on the basis of the distance calculated.

4. The recommendation apparatus as set forth in claim 1, wherein in the specifying process, the at least one processor specifies, as the recommended company, a company other than a competitor company of the target company, with reference to company information of the cooperation candidate company.

5. The recommendation apparatus as set forth in claim 4, wherein in the specifying process, the at least one processor specifies, as the competitor company, a company whose industry type corresponds to an industry type of the target company, on the basis of the cooperation candidate company information including an industry type of the cooperation candidate company.

6. The recommendation apparatus as set forth in claim 1, wherein:
in the extracting process, the at least one processor extracts the core phrases for each of a plurality of dictionaries, the plurality of dictionaries storing therein a plurality of keywords respectively; and
in the specifying process, the at least one processor specifies the recommended company on the basis of the core phrases extracted for each of the plurality of dictionaries.

7. The recommendation apparatus as set forth in claim 1, wherein in the specifying process, the at least one processor calculates a distance between feature vectors related to the core phrases extracted by the extracting process, the distance being in a predetermined feature space, and specifies the recommended company on the basis of the distance calculated.

8. The recommendation apparatus as set forth in claim 7, wherein:
in the extracting process, the at least one processor extracts the core phrases for each of a plurality of dictionaries, the plurality of dictionaries storing therein a plurality of keywords respectively; and
in the specifying process, the at least one processor calculates the distance for each of the plurality of dictionaries and specifies the recommended company on the basis of a result of the calculation for each of the plurality of dictionaries.

9. The recommendation apparatus as set forth in claim 1, wherein the at least one processor further carries out a second specifying process of specifying a first important part in the target company information and a second important part in cooperation candidate company information of the recommended company,
in the output process, the at least one processor presents the information indicative of the recommended company, the first important part, and the second important part.

10. A recommendation method, comprising:
extracting, on the basis of a predetermined extraction condition, core phrases respectively from (i) target company information including a cooperation detail desired by a target company and (ii) cooperation candidate company information including a cooperation detail desired by a cooperation candidate company of the target company;
specifying a recommended company from among the cooperation candidate company on the basis of the core phrases; and
outputting information indicative of the recommended company,
the extracting, the specifying, and the outputting being each carried out by at least one processor.

11. (canceled)

12. A non-transitory storage medium storing therein a program for causing a computer to function as a recommendation apparatus,
the program causing the computer to carry out:
an extracting process of extracting, on the basis of a predetermined extraction condition, core phrases respectively from (i) target company information including a cooperation detail desired by a target company and (ii) cooperation candidate company information including a cooperation detail desired by a cooperation candidate company of the target company;
a specifying process of specifying a recommended company from among the cooperation candidate company on the basis of the core phrases extracted by the extracting process; and
an output process of outputting information indicative of the recommended company specified by the specifying process.

13. A recommendation system, comprising the recommendation apparatus recited in claim 1 and a user terminal, in the extracting process, the at least one processor extracts, on the basis of a predetermined extraction condition, core phrases respectively from (i) target company information including a cooperation detail desired by a target company indicated by input information and (ii) cooperation candidate company information including a cooperation detail desired by a cooperation candidate company of the target company,
the user terminal including at least one processor, the at least one processor of the user terminal carrying out:
an input process of obtaining the input information; and
a displaying process of displaying the information outputted from the recommendation apparatus and indicative of the recommended company.
